(19) United States
(12) Patent Application Publication
(10) Pub. No.: US 2006/0207378 A1
(43) Pub. Date: Sep. 21, 2006

(54) Mounting structure for steering column

(75) Inventors: Paul R. Kramer, Pinconning, MI (US); Michael P. Anspaugh, Bay City, MI (US); Damir Menjak, Frankenmuth, MI (US); William D. Cymbal, Freeland, MI (US)

Correspondence Address: DELPHI TECHNOLOGIES, INC., M/C 480-410-202, PO BOX 5052, TROY, MI, 48007, US

(73) Assignee: Delphi Technologies, Inc.

(21) Appl. No.: 11/082,560

(22) Filed: Mar. 17, 2005

(51) Int. Cl. B62D 1/16

(52) U.S. Cl. 74/492

(57) ABSTRACT

The invention provides a mounting structure for engaging a vehicle with a steering column adjustable in raking movement. The mounting structure includes a compression bracket having first and second walls spaced from one another for frictionally engaging a rake bracket. A first aperture is formed in the first wall and a second aperture is formed in the second wall for receiving a rake bolt. The mounting structure also includes a first clamp cooperating with the compression bracket to define a third aperture extending along an axis to receive a steering column jacket. The first clamp is operable to reduce a size of the third aperture at a first position along the axis to selectively clamp the steering column jacket. The mounting structure also includes a second clamp cooperating with the compression bracket to define a fourth aperture centered on the axis to receive the steering column jacket. The second clamp is operable to reduce a size of the fourth aperture at a second position along the axis spaced from the first position to selectively clamp the steering column jacket.

### FIELD OF THE INVENTION

The invention relates to a mounting structure for a steering column of a vehicle and more particularly to a steering column adjustable in raking movement.

### BACKGROUND OF THE INVENTION

Steering columns adjustable in raking movement pivot about pivot axis adjacent to the bottom of the column. Raking columns can include two telescoping jackets that move in raking adjustment together between walls defined by a rake bracket mounted to the vehicle. Often, a compression bracket is fixedly mounted to an upper jacket of the two jackets. The walls of the rake bracket are urged against the compression bracket to lock the steering column.

### SUMMARY OF THE INVENTION

The invention provides a mounting structure for engaging a vehicle with a steering column adjustable in raking movement. The mounting structure includes a compression bracket having first and second walls spaced from one another for frictionally engaging a rake bracket. A first aperture is formed in the first wall and a second aperture is formed in the second wall for receiving a rake bolt. The mounting structure also includes a first clamp cooperating with the compression bracket to define a third aperture extending along an axis to receive a steering column jacket. The first clamp is operable to reduce a size of the third aperture at a first position along the axis to selectively clamp the steering column jacket. The mounting structure also includes a second clamp cooperating with the compression bracket to define a fourth aperture centered on the axis to receive the steering column jacket. The second clamp is operable to reduce a size of the fourth aperture at a second position along the axis spaced from the first position to selectively clamp the steering column jacket.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is an exploded view of a steering column assembly incorporating a first exemplary embodiment of the invention;

FIG. 2 is a front view of the first exemplary embodiment of the invention;

FIG. 3 is a cross-sectional view taken along section lines 3-3 in FIG. 2;

FIG. 4 is a cross-sectional view of a second exemplary embodiment of the invention corresponding to the cross-sectional view of FIG. 3;

FIG. 5 is a front view of a third exemplary embodiment of the invention;

FIG. 6 is a cross-sectional view taken along section lines 6-6 in FIG. 5;

FIG. 7 is a cross-sectional view taken along section lines 7-7 in FIG. 5;

FIG. 8 is a cross-sectional view of a fourth exemplary embodiment of the invention corresponding to the cross-sectional views of FIGS. 3, 6 and 7;

FIG. 9 is a cross-sectional view of a fifth exemplary embodiment of the invention corresponding to the cross-sectional views of FIGS. 3 and 6-8;

FIG. 10 is a front view of a sixth exemplary embodiment of the invention;

FIG. 11 is a cross-sectional view taken along section lines 11-11 in FIG. 10;

FIG. 12 is a front view of a seventh exemplary embodiment of the invention;

FIG. 13 is a cross-sectional view of a eighth exemplary embodiment of the invention corresponding to the cross-sectional views of FIGS. 3 and 6-9;

FIG. 14 is a cross-sectional view of a ninth exemplary embodiment of the invention corresponding to the cross-sectional views of FIGS. 3, 6-9 and 13; and

FIG. 15 is a cross-sectional view of a tenth exemplary embodiment of the invention corresponding to the cross-sectional views of FIGS. 3, 6-9 and 13-14.

### DETAILED DESCRIPTION OF THE PREFERRED EMBODIMENT

A plurality of different embodiments of the invention are shown in the Figures of the application. Similar features are shown in the various embodiments of the invention. Similar features have been numbered with a common reference numeral and have been differentiated by an alphabetic designation. Similar features are structured similarly, operate similarly, and/or have the same function unless otherwise indicated by the drawings or this specification. Furthermore, particular features of one embodiment can replace corresponding features in another embodiment unless otherwise indicated by the drawings or this specification.

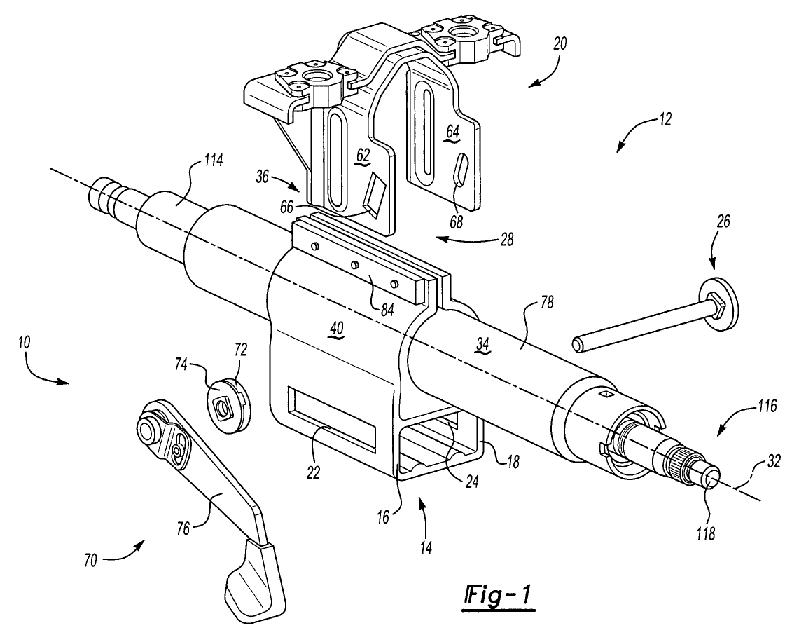

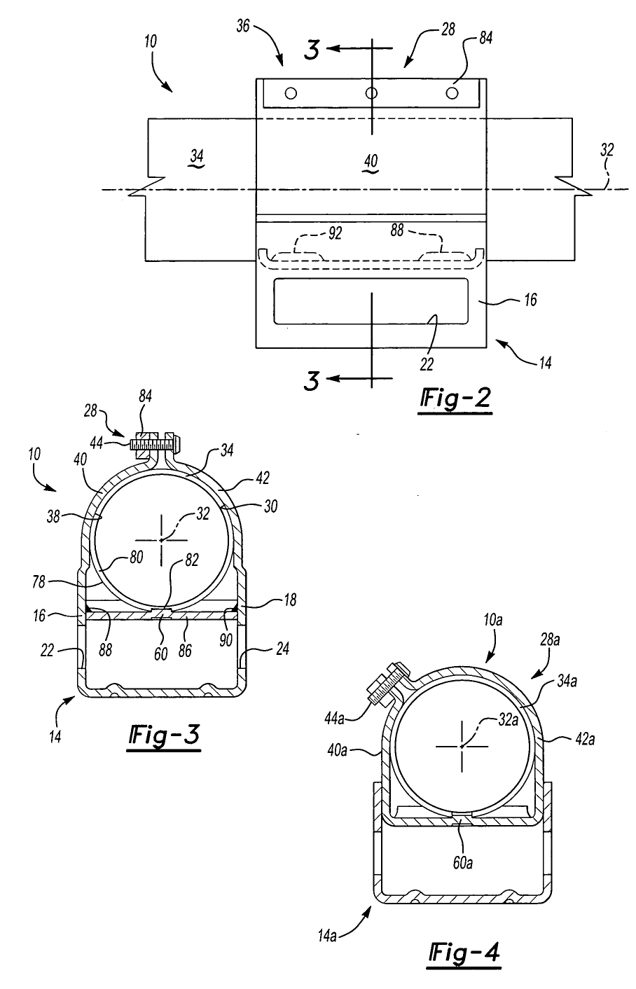

Referring now to FIGS. 1-3, in a first exemplary embodiment of the invention, a mounting structure 10 for engaging a vehicle with a steering column 12 adjustable in raking movement includes a compression bracket 14 having first and second walls 16, 18 spaced from one another. The first and second walls 16, 18 frictionally engage a rake bracket 20. A first aperture 22 is formed in the first wall 16 and a second aperture 24 is formed in the second wall 18. The first and second apertures 16, 18 receive a rake bolt 26. The mounting structure 10 also includes a first clamp 28 cooperating with the compression bracket 14 to define a third aperture 30 extending along an axis 32 to receive a steering column jacket 34. The first clamp 28 is operable to reduce a size of the third aperture 30 at a first position along the axis 32 to selectively clamp the steering column jacket 34. The mounting structure 10 also includes a second clamp 36 cooperating with the compression bracket 14 to define a fourth aperture 38 centered on the axis 32 to receive the steering column jacket 34. The second clamp 36 is operable to reduce a size of the fourth aperture 38 at a second position along the axis 32 spaced from the first position to selectively clamp the steering column jacket 34.

Both of the first and second clamps 28, 36 are structured similarly to one another an operate similarly. The structure and operation of the clamp 28 will be described in more detail and the description is applicable to the second clamp 36. The first clamp 28 includes first and second halves 40, 42 spaced from one another about the axis 32. A gap is defined between the first and second halves 40, 42 one hundred and eighty degrees from the compression bracket 14. Each of the first and second halves 40, 42 is fixed to the compression bracket 14 at an end opposite the gap. In the first exemplary embodiment of the invention, the first and second halves 40, 42 are integral with the compression bracket 14. A first bolt 44 is threadingly engaged with both of the first and second halves 40, 42 and rotatable. The ends of the first and second halves 40, 42 adjacent to the gap move relative to one another, closer together, in response to rotation of the first bolt 44 in a first direction. The ends of the first and second halves 40, 42 adjacent to the gap move relative to one another, further apart, in response to rotation of the first bolt 44 in a second direction. The first clamp 28 is adjustable based on the cooperation between the first bolt 44 and the first and second halves 40, 42; clamping force being operable to increase in response to increased rotation of the first bolt 44 in the first direction and decrease in response to increased rotation of the first bolt 44 in the second direction. The first half 40 of the first exemplary embodiment of the invention includes a plate 84 defining threads for receiving the first bolt 44. In alternative embodiments of the invention, the first bolt 44 could be self-tapping.

The compression bracket 14 includes a cross channel 86 to enhance the strength of the compression bracket 14. The cross channel 86 is engaged with the first and second walls 16, 18 by welds such as welds 88, 90, 92. A projection 60 extends from the cross channel 86 of the compression bracket 14. The projection is received in a slot 82 formed in the steering column jacket 34. The cooperation between the projection 60 and the slot 82 aligns the compression bracket 14 and the steering column jacket 34 with respect to one another. In alternative embodiments of the invention, a projection could extend between the steering column jacket 34 and one of the first and second halves 40, 42. Also, in alternative embodiments of the invention, a slot for receiving a projection could be defined in any of the first half 40, the second half 42, or the compression bracket 14.

Referring now to FIG. 4, in a second exemplary embodiment of the invention, a mounting structure l0a includes a clamp 28a structured similarly to and operating similarly with respect to clamp 28. The first clamp 28a includes first and second halves 40a, 42a spaced from one another about the axis 32a. A gap is defined between the first and second halves 40a, 42a less than one hundred and eighty degrees from a compression bracket 14a. Each of the first and second halves 40a, 42a is fixed to the compression bracket 14a at an end opposite the gap. A self-tapping first bolt 44a is threadingly engaged with both of the first and second halves 40a, 42a and rotatable. A projection 60a extends from the compression bracket 14a and is received in a slot formed in the steering column jacket 34a.

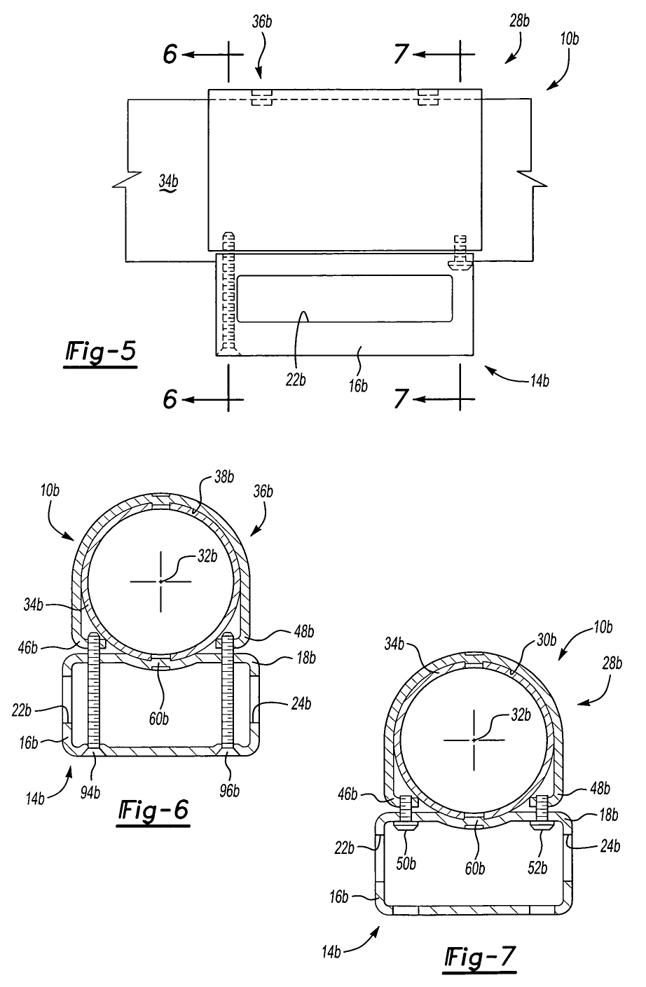

Referring now to FIGS. 5-7, in a third exemplary embodiment of the invention, a mounting structure 10b for engaging a vehicle with a steering column adjustable in raking movement (such as steering column 12 in FIG. 1) includes a compression bracket 14b having first and second walls 16b, 18b spaced from one another. The first and second walls 16b, 18b frictionally engaging a rake bracket (such as rake bracket 20 in FIG. 1). A first aperture 22b is formed in the first wall 16b and a second aperture 24b is formed in the second wall 18b. The first and second apertures 16b, 18b receive a rake bolt (such as rake bolt 26 in FIG. 1). The mounting structure 10b also includes a first clamp 28b cooperating with the compression bracket 14b to define a third aperture 30b extending along an axis 32b to receive a steering column jacket 34b. The first clamp 28b is operable to reduce a size of the third aperture 30b at a first position along the axis 32b to selectively clamp the steering column jacket 34b. The mounting structure 10b also includes a second clamp 36b cooperating with the compression bracket 14b to define a fourth aperture 38b centered on the axis 32b to receive the steering column jacket 34b. The second clamp 36b is operable to reduce a size of the fourth aperture 38b at a second position along the axis 32b spaced from the first position to selectively clamp the steering column jacket 34b.

Both of the first and second clamps 28b, 36b are structured similarly to one another an operate similarly. In the third exemplary embodiment of the invention, the first and second clamps 28b, 36b are substantially integral with one another. The structure and operation of the clamp 28b will be described in more detail and the description is applicable to the second clamp 36b. The first clamp 28b extends between first and second ends 46b, 48b releasibly engaged with the compression bracket 14b. A second bolt 50b is threadingly engaged with the first end 46b and with the compression bracket 14b. A third bolt 52b is threadingly engaged with the second end 48b and with the compression bracket 14b. The first end 46b moves closer to the compression bracket 14b in response to rotation of the second bolt 50b in a first direction. The first end 46b moves away from the compression bracket 14b in response to rotation of the second bolt 50b in a second direction. Likewise, the second end 48b moves closer to the compression bracket 14b in response to rotation of the third bolt 52b in a first direction and moves away from the compression bracket 14b in response to rotation of the third bolt 52b in a second direction. The first clamp 28b is adjustable based on the cooperation between the second and third bolts 50b, 52b, the compression bracket 14b and the first and second ends 46b, 48b; clamping force being operable to increase in response to increased rotation of the second and third bolts 50b, 52b in the first direction and to decrease in response to increased rotation of the second and third bolts 50b, 52b in the second direction. A projection 60b extends from the compression bracket 14b and is received in a slot formed in the steering column jacket 34b.

The second and third bolts 50b, 52b of the first clamp 28b extend through a single side of the compression bracket 14b. Corresponding bolts 94b and 96b extend through two sides of the compression bracket 14b, bottom and top sides. The arrangement of bolts can be selected to simplify the assembly of the compression bracket 14b to the first and second clamps 28b, 36b.

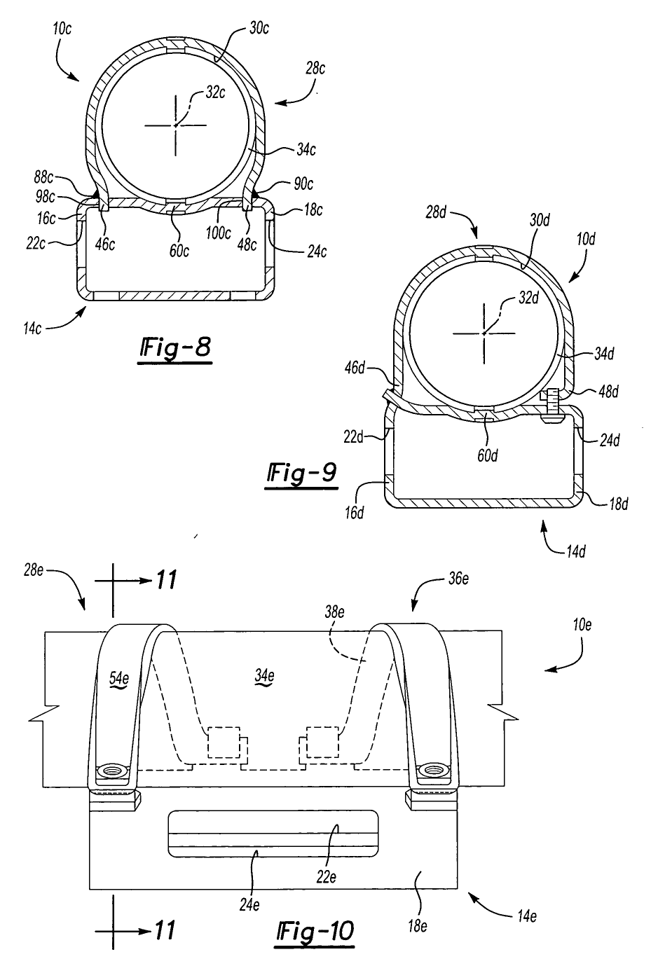

Referring now to FIG. 8, in a fourth exemplary embodiment of the invention, a mounting structure 10c for engaging a vehicle with a steering column adjustable in raking movement (such as steering column 12 in FIG. 1) includes a compression bracket 14c having first and second walls 16c, 18c spaced from one another. The first and second walls 16c, 18c frictionally engaging a rake bracket (such as rake bracket 20 in FIG. 1). A first aperture 22c is formed in the first wall 16c and a second aperture 24c is formed in the second wall 18c. The first and second apertures 16c, 18c receive a rake bolt (such as rake bolt 26 in FIG. 1). The mounting structure 10c also includes a first clamp 28c cooperating with the compression bracket 14c to define a third aperture 30c extending along an axis 32c to receive a steering column jacket 34c. The first clamp 28c is operable to reduce a size of the third aperture 30c at a first position along the axis 32c to selectively clamp the steering column jacket 34c. The mounting structure 10c also includes a second clamp cooperating with the compression bracket 14c to define a fourth aperture centered on the axis 32c to receive the steering column jacket 34c. The second clamp is operable to reduce a size of the fourth aperture at a second position along the axis 32c spaced from the first position to selectively clamp the steering column jacket 34c. The second clamp is not shown in the Figure; however the second clamp is structured similarly as first clamp 28c.

The first clamp 28c extends between first and second ends 46c, 48c fixed to the compression bracket 14c. During assembly, the first and second ends 46c, 48c are extended through slots 98c, 100c formed in the compression bracket 14c. The first and second ends 46c, 48c are then fixedly connected to the compression bracket 14c with welds 88c, 90c. A projection 60c extends from the compression bracket 14c and is received in a slot formed in the steering column jacket 34c.

Referring now to FIG. 9, in a fifth exemplary embodiment of the invention, a mounting structure 10d for engaging a vehicle with a steering column adjustable in raking movement (such as steering column 12 in FIG. 1) includes a compression bracket 14d having first and second walls 16d, 18d spaced from one another. The first and second walls 16d, 18d frictionally engaging a rake bracket (such as rake bracket 20 in FIG. 1). A first aperture 22d is formed in the first wall 16d and a second aperture 24d is formed in the second wall 18d. The first and second apertures 16d, 18d receive a rake bolt (such as rake bolt 26 in FIG. 1). The mounting structure 10d also includes a first clamp 28d cooperating with the compression bracket 14d to define a third aperture 30d extending along an axis 32d to receive a steering column jacket 34d. The first clamp 28d is operable to reduce a size of the third aperture 30d at a first position along the axis 32d to selectively clamp the steering column jacket 34d. The mounting structure 10d also includes a second clamp cooperating with the compression bracket 14d to define a fourth aperture centered on the axis 32d to receive the steering column jacket 34d. The second clamp is operable to reduce a size of the fourth aperture at a second position along the axis 32d spaced from the first position to selectively clamp the steering column jacket 34d. The second clamp is not shown in the Figure; however the second clamp is structured similarly as first clamp 28d.

The fifth exemplary embodiment of the invention includes features of the third and fourth exemplary embodiments of the invention. The first clamp 28d extends between a first end 46d fixedly engaged with the compression bracket 14d and a second end 48d releasibly engaged with the compression bracket 14d. A projection 60d extends from the compression bracket 14d and is received in a slot formed in the steering column jacket 34d.

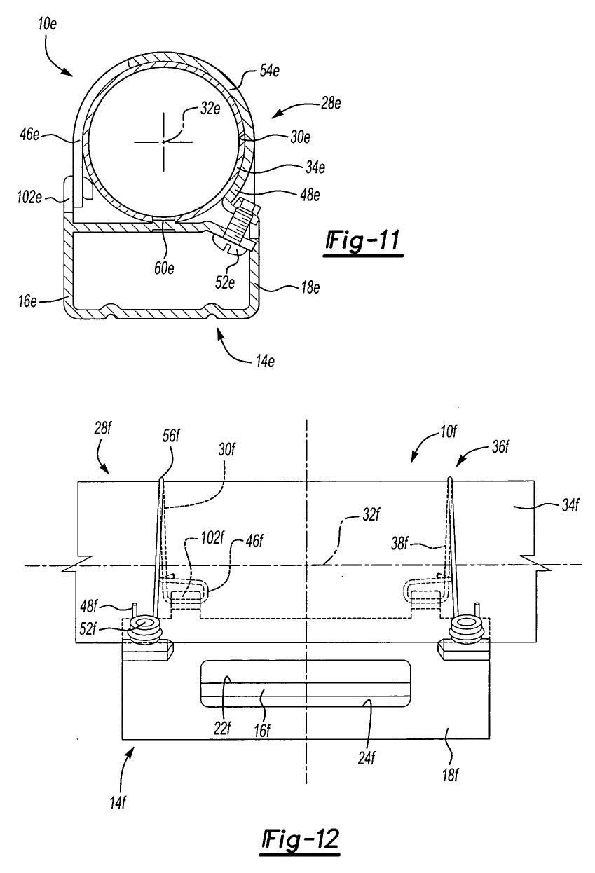

Referring now to FIGS. 10 and 11, in a sixth exemplary embodiment of the invention, a mounting structure 10e for engaging a vehicle with a steering column adjustable in raking movement (such as steering column 12 in FIG. 1) includes a compression bracket 14e having first and second walls 16e, 18e spaced from one another. The first and second walls 16e, 18e frictionally engaging a rake bracket (such as rake bracket 20 in FIG. 1). A first aperture 22e is formed in the first wall 16e and a second aperture 24e is formed in the second wall 18e. The first and second apertures 16e, 18e receive a rake bolt (such as rake bolt 26 in FIG. 1). The mounting structure 10e also includes a first clamp 28e cooperating with the compression bracket 14e to define a third aperture 30e extending along an axis 32e to receive a steering column jacket 34e. The first clamp 28e is operable to reduce a size of the third aperture 30e at a first position along the axis 32e to selectively clamp the steering column jacket 34e. The mounting structure 10e also includes a second clamp 36e cooperating with the compression bracket 14e to define a fourth aperture 38e centered on the axis 32e to receive the steering column jacket 34e. The second clamp 36e is operable to reduce a size of the fourth aperture 38e at a second position along the axis 32e spaced from the first position to selectively clamp the steering column jacket 34e.

Both of the first and second clamps 28e, 36e are structured similarly to one another and operate similarly. In the sixth exemplary embodiment of the invention, the first and second clamps 28e, 36e are not integral with one another, being spaced from one another. The structure and operation of the clamp 28e will be described in more detail and the description is applicable to the second clamp 36e. The first clamp 28e is formed as a strap 54e and extends between first and second ends 46e, 48e releasibly engaged with the compression bracket 14e. The first end 46e is formed as a hook and engages a hook 102e of the compression bracket 14e. The hook of the first end 46e and the hook 102e arcuately extend in perpendicular planes, best seen when comparing FIGS. 10 and 11. A third bolt 52e is threadingly engaged with the second end 48e and with the compression bracket 14e. The second end 48e moves closer to the compression bracket 14e in response to rotation of the third bolt 52e in a first direction and moves further from the compression bracket 14e in response to rotation of the third bolt 52e in a second direction. The first clamp 28e is adjustable based on the cooperation between the third bolt 52e, the compression bracket 14e and the second end 48e; clamping force being operable to increase in response to increased rotation of the third bolt 52e in the first direction and to decrease in response to increased rotation of the third bolt 52e in the second direction. A projection 60e extends from the compression bracket 14e and is received in a slot formed in the steering column jacket 34e.

Referring now to FIG. 12, in a seventh exemplary embodiment of the invention, a mounting structure 10f for engaging a vehicle with a steering column (such as steering column 12 in FIG. 1) adjustable in raking movement includes a compression bracket 14f having first and second walls 16f, 18f spaced from one another. The first and second walls 16f, 18f frictionally engaging a rake bracket (such as rake bracket 20 in FIG. 1). A first aperture 22f is formed in the first wall 16f and a second aperture 24f is formed in the second wall 18f. The first and second apertures 16f, 18f receive a rake bolt (such as rake bolt 26 in FIG. 1). The mounting structure 10f also includes a first clamp 28f cooperating with the compression bracket 14f to define a third aperture 30f extending along an axis 32f to receive a steering column jacket 34f. The first clamp 28f is operable to reduce a size of the third aperture 30f at a first position along the axis 32f to selectively clamp the steering column jacket 34f. The mounting structure 10f also includes a second clamp 36f cooperating with the compression bracket 14f to define a fourth aperture 38f centered on the axis 32f to receive the steering column jacket 34f. The second clamp 36f is operable to reduce a size of the fourth aperture 38f at a second position along the axis 32f spaced from the first position to selectively clamp the steering column jacket 34f.

Both of the first and second clamps 28f, 36f are structured similarly to one another an operate similarly. In the seventh exemplary embodiment of the invention, the first and second clamps 28f, 36f are spaced from one another. The structure and operation of the clamp 28f will be described in more detail and the description is applicable to the second clamp 36f. The first clamp 28f is formed as a wire 56f and extends between first and second ends 46f, 48f releasibly engaged with the compression bracket 14f. The first end 46f is formed as a hoop and engages a hook 102f of the compression bracket 14f. A third bolt 52f is threadingly engaged with the second end 48f and with the compression bracket 14f. The second end 48f moves closer to the compression bracket 14f in response to rotation of the third bolt 52f in a first direction and moves further from the compression bracket 14f in response to rotation of the third bolt 52f in a second direction. The first clamp 28f is adjustable based on the cooperation between the third bolt 52f, the compression bracket 14f and the second end 48f; clamping force being operable to increase in response to increased rotation of the third bolt 52f in the first direction and decrease in response to increased rotation of the third bolt 52f in the second direction.

Referring now to FIG. 13, in an eighth exemplary embodiment of the invention, a mounting structure 10g for engaging a vehicle with a steering column adjustable in raking movement (such as steering column 12 in FIG. 1) includes a compression bracket 14g having first and second walls 16g, 18g spaced from one another. The first and second walls 16g, 18g frictionally engaging a rake bracket (such as rake bracket 20 in FIG. 1). A first aperture 22g is formed in the first wall 16g and a second aperture 24g is formed in the second wall 18g. The first and second apertures 16g, 18g receive a rake bolt (such as rake bolt 26 in FIG. 1). The mounting structure 10g also includes a first clamp 28g formed as a strap 54g with punch-outs and extending between first and second ends 46g, 48g releasibly engaged with the compression bracket 14g. The first clamp 28g defines an aperture 30g centered on an axis 32g. The aperture 30g receives a steering column jacket 34g. The first end 46g is formed as a hoop and engages a pin 104g of the compression bracket 14g. A third bolt 52g is threadingly engaged with the second end 48g and is supported for stationary rotation by the compression bracket 14g. The second end 48g is drawn further into the interior defined by the compression bracket 14g in response to rotation of the third bolt 52g in a first direction and moves out of the interior of the compression bracket 14g in response to rotation of the third bolt 52g in a second direction. The first clamp 28g is a hose clamp.

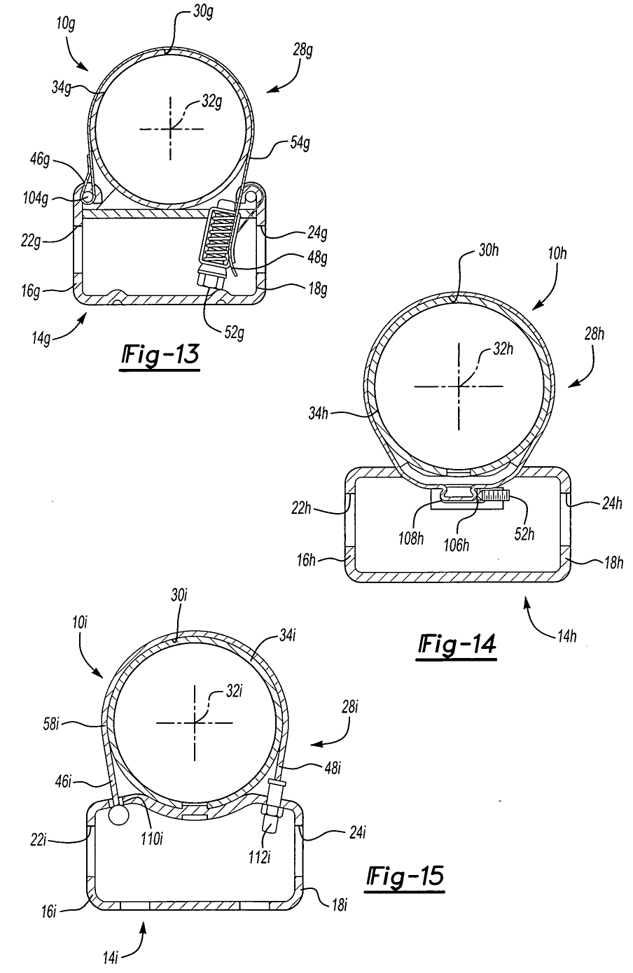

Referring now to FIG. 14, in a ninth exemplary embodiment of the invention, a mounting structure 10h for engaging a vehicle with a steering column (such as steering column 12 in FIG. 1) adjustable in raking movement includes a compression bracket 14h having first and second walls 16h, 18h spaced from one another. The first and second walls 16h, 18h frictionally engaging a rake bracket (such as rake bracket 20 in FIG. 1). A first aperture 22h is formed in the first wall 16h and a second aperture 24h is formed in the second wall 18h. The first and second apertures 16h, 18h receive a rake bolt (such as rake bolt 26 in FIG. 1). The mounting structure 10h also includes a first clamp 28h cooperating with the compression bracket 14h to define a third aperture 30h extending along an axis 32h to receive a steering column jacket 34h. The first clamp 28h is operable to reduce a size of the third aperture 30h at a first position along the axis 32h to selectively clamp the steering column jacket 34h. The mounting structure 10h also includes a second clamp cooperating with the compression bracket 14h to define a fourth aperture centered on the axis 32h to receive the steering column jacket 34h. The second clamp is operable to reduce a size of the fourth aperture at a second position along the axis 32h spaced from the first position to selectively clamp the steering column jacket 34h. The second clamp is not shown in the Figure; however the second clamp is structured similarly as first clamp 28h.

The clamp 28h is known as a Detiker clamp. A third bolt 52h is rotatable and moves axially in response to rotation. The third bolt 52h moves an anvil 106h to pinch a loop portion 108h a strap 54h of the first clamp 28h and decrease the size of the aperture 30h.

Referring now to FIG. 15, in a tenth exemplary embodiment of the invention, a mounting structure 10i for engaging a vehicle with a steering column adjustable in raking movement (such as steering column 12 in FIG. 1) includes a compression bracket 14i having first and second walls 16i, 18i spaced from one another. The first and second walls 16i, 18i frictionally engaging a rake bracket (such as rake bracket 20 in FIG. 1). A first aperture 22i is formed in the first wall 16i and a second aperture 24i is formed in the second wall 18i. The first and second apertures 16i, 18i receive a rake bolt (such as rake bolt 26 in FIG. 1). The mounting structure 10i also includes a first clamp 28i cooperating with the compression bracket 14i to define a third aperture 30i extending along an axis 32i to receive a steering column jacket 34i. The first clamp 28i is operable to reduce a size of the third aperture 30i at a first position along the axis 32i to selectively clamp the steering column jacket 34i. The mounting structure 10i also includes a second clamp cooperating with the compression bracket 14i to define a fourth aperture centered on the axis 32i to receive the steering column jacket 34i. The second clamp is operable to reduce a size of the fourth aperture at a second position along the axis 32i spaced from the first position to selectively clamp the steering column jacket 34i. The second clamp is not shown in the Figure; however the second clamp is structured similarly as first clamp 28i.

The first clamp 28i is formed as a cable 58i and extends between first and second ends 46i, 48i releasibly engaged with the compression bracket 14i. The first end 46i is formed as a ball and engages a slot 110i. The ball is larger than the slot 110i. A threaded member 112i engages the second end 48i and the compression bracket 14i. The second end 48i is drawn further into an interior defined by the compression bracket 14i in response to rotation of the threaded member 112i in a first direction and moves out of the interior in response to rotation of the threaded member 112i in a second direction.

Referring again to FIGS. 1-3, the steering column 12 includes the steering column jacket 34 and a second steering column jacket 114. The jackets 34, 114 house a steering shaft 116 having a steering wheel supporting end 118 and are telescopically adjustable relative to one another. The lengths of the apertures 16 and 18 define the length of telescopic adjustment between the jackets 34, 114. The apertures 16 and 18 of the first exemplary embodiment are slot-like. The steering column jacket 34 includes outer and inner surfaces 78, 80 and extends through the third and fourth apertures 30, 38. The first and second clamps 28, 36 exert a pressing force against the outer surface 78 such that the inner surface 80 is undistorted to fixedly engage the compression bracket 14 and the steering column jacket 34 relative to one another. When a compression bracket is welded to a steering column jacket, the inner surface of the jacket can be distorted which can be undesirable.

The rake bracket 20 is operable to be mounted to a vehicle. The rake bracket includes a third wall 62 facing the first wall 16 and a fourth wall 64 facing the second wall 18. The steering column jacket 34, compression bracket 14 and clamps 28, 30 move along an arcuate path between the walls 62, 64 to adjust the steering wheel supporting end 118 in raking movement. A fifth aperture 66 is formed in the third wall 62 and a sixth aperture 68 is formed in the fourth wall 64. The lengths of the apertures 66 and 68 define the length of adjusting raking movement.

A locking device 70 concurrently urges the third wall 62 against the first wall 16 and the fourth wall 64 against the second wall 18 to lock the steering column 12, preventing telescopic and raking adjustment. The locking device 70 includes the rake bolt 26 that extends through the first and second and fifth and sixth apertures 22, 24, 66, 68. The locking device 70 also includes first and second cams 72, 74 disposed on the rake bolt 26 and a lever 76 disposed to rotate one of the first and second cams 72, 74 relative to the other of the first and second cams 72, 74. When the lever 76 rotates from an unlocked position to a locked position, the cams 72, 74 rotate relative to one another and urge each other apart. The cam 74 can be fixed to the lever 76 and the cam 72 can be slidably received in the fifth aperture 66. Cooperation between the cam 72 and the fifth aperture 66 allows the cam 72 to move in the slot during raking movement and prevents the cam 72 from rotating about the bolt 26. Movement of the cams 72, 74 apart from one another, in cooperation with a head 120 of the bolt 26, presses the walls 16, 18, 62, 64 together.

In alternative embodiments of the invention, any of the ten exemplary embodiments of clamps can be used in conjunction with any other embodiment of clamp to cooperate with a compression bracket to define third and fourth apertures for receiving a steering column jacket.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not to be limited to the particular embodiment disclosed as the best mode contemplated for carrying out this invention, but that the invention will include all embodiments falling within the scope of the appended claims.

What is claimed is:

1. A mounting structure for engaging a vehicle with a steering column adjustable in raking movement comprising:
a compression bracket having first and second walls spaced from one another for frictionally engaging a rake bracket and a first aperture in said first wall and a second aperture in said second wall for receiving a rake bolt;
a first clamp cooperating with said compression bracket to define a third aperture extending along an axis to receive a steering column jacket wherein said first clamp being operable to reduce a size of said third aperture at a first position along said axis to selectively clamp the steering column jacket; and
a second clamp cooperating with said compression bracket to define a fourth aperture centered on said axis to receive the steering column jacket wherein said second clamp being operable to reduce a size of said fourth aperture at a second position along said axis spaced from said first position to selectively clamp the steering column jacket.

2. The mounting structure of claim 1 wherein at least one of said first and second clamps are adjustable.

3. The mounting structure of claim 2 wherein both of said first and second clamps are adjustable.

4. The mounting structure of claim 1 wherein each of said first and second clamps further comprises:
first and second halves spaced from one another about said axis and each being fixed to said compression bracket; and
a first bolt threadingly engaged with both of said first and second halves and rotatable to move said first and second halves relative to one another.

5. The mounting structure of claim 4 wherein said first bolt is spaced less than one hundred and eighty degrees from said compression bracket about said axis.

6. The mounting structure of claim 1 wherein each of said first and second clamps extends between first and second ends releasibly engaged with said compression bracket.

7. The mounting structure of claim 6 wherein each of said first and second clamps further comprises:
a second bolt threadingly engaged with said first end and with said compression bracket; and
a third bolt threadingly engaged with said second end and with said compression bracket.

8. The mounting structure of claim 7 wherein said second and third bolts extend through a single side of said compression bracket.

9. The mounting structure of claim 6 wherein each of said first and second clamps includes one of a strap and a wire and a cable.

10. The mounting structure of claim 1 wherein each of said first and second clamps extends between a first end fixedly engaged with said compression bracket and a second end releasibly engaged with said compression bracket.

11. The mounting structure of claim 1 wherein each of said first and second clamps extends between first and second ends fixed to said compression bracket.

12. The mounting structure of claim 1 further comprising:
at least one projection extending into one of said third and fourth apertures toward said axis for aligning said compression bracket with the steering column jacket.

13. The mounting structure of claim 1 further comprising:
a rake bracket operable to be mounted to a vehicle and having third wall facing said first wall and a fourth wall facing said second wall and fifth aperture formed in said third wall and a sixth aperture formed in said fourth wall; and
a locking device having a rake bolt extending through said first and second and fifth and sixth apertures and also having first and second cams disposed on said rake bolt and also having a lever disposed to rotate one of said first and second cams relative to the other of said first and second cams to urge said third and fourth walls against said first and second walls.

14. The mounting structure of claim 1 further comprising:
a steering column jacket having outer and inner surfaces and extending through said third and fourth apertures wherein said first and second clamps exert a pressing force against said outer surface such that said inner surface is undistorted to fixedly engage said compression bracket and said steering column jacket relative to one another.

15. A mounting structure for engaging a vehicle with a steering column adjustable in raking movement comprising:
a compression bracket having first and second walls spaced from one another for frictionally engaging a rake bracket and a first aperture in said first wall and a second aperture in said second wall;
a first clamp cooperating with said compression bracket to define a third aperture extending along an axis to receive a steering column jacket wherein said first clamp being operable to reduce a size of said third aperture at a first position along said axis to selectively clamp the steering column jacket;
a second clamp cooperating with said compression bracket to define a fourth aperture centered on said axis to receive the steering column jacket wherein said second clamp being operable to reduce a size of said fourth aperture at a second position along said axis spaced from said first position to selectively clamp the steering column jacket
a steering column jacket having outer and inner surfaces and extending through said third and fourth apertures wherein said first and second clamps exert a pressing force against said outer surface such that said inner surface is undistorted to fixedly engage said compression bracket and said steering column jacket relative to one another;
a rake bracket operable to be mounted to a vehicle and having third wall facing said first wall and a fourth wall facing said second wall and fifth aperture formed in said third wall and a sixth aperture formed in said fourth wall; and
a locking device having a rake bolt extending through said first and second and fifth and sixth apertures and also having first and second cams disposed on said rake bolt and also having a lever disposed to rotate one of said first and second cams relative to the other of said first and second cams to urge said third and fourth walls against said first and second walls;
at least one projection extending in one of said third and fourth apertures between said steering column jacket and one of said compression bracket and said respective first and second clamps;
a slot disposed to received said projection and formed in one of said steering column jacket and said compression bracket and said first clamp and said second clamp for aligning said compression bracket with the steering column jacket.

16. A method for engaging a vehicle with a steering column adjustable in raking movement comprising the steps of:
spacing first and second walls of a compression bracket from one another for frictionally engaging a rake bracket wherein the compression bracket also includes a first aperture in the first wall and a second aperture in the second wall for receiving a rake bolt;
selectively clamping the steering column jacket with a first clamp cooperating with the compression bracket to define a third aperture extending along an axis and receiving a steering column jacket wherein the first clamp being operable to reduce a size of the third aperture at a first position along the axis; and
selectively clamping the steering column jacket with a second clamp cooperating with the compression bracket to define a fourth aperture centered on the axis to receive the steering column jacket wherein the second clamp being operable to reduce a size of the fourth aperture at a second position along the axis spaced from the first position.
